(19) United States
(12) Patent Application Publication
(10) Pub. No.: US 2026/0125981 A1
(43) Pub. Date: May 7, 2026

(54) TURBINE ENGINE SYSTEM

(71) Applicant: HELENG INC., Temple City, CA (US)

(72) Inventor: Jack Ing Jeng, Arcadia, CA (US)

(73) Assignee: HELENG INC., Temple City, CA (US)

(21) Appl. No.: 19/374,428

(22) Filed: Oct. 30, 2025

Related U.S. Application Data
(60) Provisional application No. 63/715,559, filed on Nov. 2, 2024.
(60) Provisional application No. 63/818,823, filed on Jun. 6, 2025.

(51) Int. Cl. F01D 1/02; F01D 5/18

(52) U.S. Cl. CPC F01D 1/026; F01D 5/18; F05D 2220/31; F05D 2240/241; F05D 2250/241

(57) ABSTRACT

Disclosed is a turbine engine including a housing defining an interior cavity. A shaft extends axially through the housing and a turbine rotor coupled to the shaft. The turbine rotor includes a hub configured to couple to the shaft. A plurality of spokes extend radially outward from the hub. A plurality of blades is included, and each blade is disposed at a distal end of a corresponding spoke of the plurality of spokes and shaped as a hollow spherical shell having an opening. The opening is oriented to receive a working fluid and direct the working fluid tangentially to impart rotational motion to the turbine rotor. An inlet is coupled to the housing and configured to direct the working fluid into the interior cavity. An exhaust pipe is coupled to the housing and configured to discharge residual gases from the housing.

### CROSS REFERENCE TO RELATED APPLICATIONS

This application claims priority to U.S. Provisional Ser. No. 63/715,559 filed on Nov. 2, 2024, and U.S. Provisional Ser. No. 63/818,823 filed on Jun. 6, 2025, both of which are hereby incorporated by reference in full.

### BACKGROUND

Turbine engines convert the energy of a pressurized working fluid into mechanical work by directing the fluid through stationary and rotating components that extract momentum and produce shaft power. Gas turbines typically operate on a Brayton cycle using combustion gases, while steam turbines operate on a Rankine cycle using externally generated vapor. Gas turbines offer high specific power and favorable power to weight ratio but face challenges such as thermal management, blade durability, emissions control, and efficiency at part load. Steam turbines provide high efficiency in steady operation but require large auxiliary systems, have slower dynamic response, and involve significant footprint and complexity.

### SUMMARY

Disclosed is a turbine engine including a housing defining an interior cavity. A shaft extends axially through the housing and a turbine rotor coupled to the shaft. The turbine rotor includes a hub configured to couple to the shaft. A plurality of spokes extend radially outward from the hub. A plurality of blades is included, and each blade is disposed at a distal end of a corresponding spoke of the plurality of spokes and shaped as a hollow spherical shell having an opening. The opening is oriented to receive a working fluid and direct the working fluid tangentially to impart rotational motion to the turbine rotor. An inlet is coupled to the housing and configured to direct the working fluid into the interior cavity. An exhaust pipe is coupled to the housing and configured to discharge residual gases from the housing.

Disclosed is a turbine rotor including a hub configured to couple to a shaft. A plurality of spokes extend radially outward from the hub. A plurality of blades are included and each blade is disposed at a distal end of a corresponding spoke and shaped as a hollow spherical shell having an opening. The opening is oriented to receive the working fluid and direct the working fluid tangentially to impart rotational motion to the turbine rotor.

### BRIEF DESCRIPTION OF THE DRAWINGS

FIG. 1A is a perspective view of a turbine engine, in accordance with some aspects.

FIG. 1B is a front view of a turbine engine, in accordance with some aspects.

FIG. 1C is a side view of a turbine engine, in accordance with some aspects.

FIG. 1D is an exploded view of a turbine engine shown in FIGS. 1A-1C, in accordance with some aspects.

FIG. 2A is a perspective view of a turbine rotor, in accordance with some aspects.

FIG. 2B is an exploded view of a turbine rotor of FIG. 2A, in accordance with some aspects.

FIG. 3A is a perspective view of a turbine engine with a portion of the enclosure removed, in accordance with some aspects.

FIG. 3B is a perspective view of a blade, in accordance with some aspects.

FIG. 3C is a front view of a blade, in accordance with some aspects.

FIG. 3D is a side view of a blade, in accordance with some aspects.

FIG. 4A is a side view of a turbine rotor, in accordance with some aspects.

FIG. 4B is a perspective view of a portion of the turbine rotor in the interior cavity, in accordance with some aspects.

FIG. 4C is a front view of a portion of the turbine rotor in the interior cavity, in accordance with some aspects.

FIG. 4D is a perspective view of a blade, in accordance with some aspects.

FIG. 4E is a front view of a blade, in accordance with some aspects.

FIG. 4F is a perspective view of a blade, in accordance with some aspects

FIG. 5A is a side view of a turbine rotor, in accordance with some aspects.

FIG. 5B is a perspective view of a blade including a baffle, in accordance with some aspects.

FIG. 5C is a perspective view of the baffle itself, in accordance with some aspects.

FIG. 5D shows a perspective view of a blade including a baffle, in accordance with some aspects.

FIG. 5E is a side view of a blade including a baffle, in accordance with some aspects.

FIG. 5F depicts a perspective view of the baffle itself, in accordance with some aspects.

FIG. 5G is a perspective view of a blade including a baffle, in accordance with some aspects.

FIG. 6 is a perspective view of a turbine engine with a portion of the enclosure removed, in accordance with some aspects.

FIG. 7A is a perspective view of a combustion assembly, in accordance with some aspects.

FIG. 7B is a front view of a turbine engine with a portion of a housing removed, in accordance with some aspects.

FIGS. 8A-8E depict blades of the turbine rotor in various orientations, all in accordance with some aspects.

FIG. 9A is a perspective view of a combustion assembly, in accordance with some aspects.

FIGS. 9B and 9C are perspective views of a combustion assembly with the combustion chamber removed, both in accordance with some aspects.

FIG. 10A is a perspective view of an air intake valve of the combustion chamber in an open position, in accordance with some aspects.

FIG. 10B is a perspective view of an air intake valve of the combustion chamber in a closed position, in accordance with some aspects.

FIGS. 10C and 10D are side views of a combustion assembly with the combustion chamber removed, both in accordance with some aspects.

FIGS. 11A and 11B are front views of a portion of the turbine engine with a portion of a housing removed, both in accordance with some aspects.

FIG. 12A is a front view of a turbine engine, in accordance with some aspects.

FIG. 12B is a side view of a turbine engine, in accordance with some aspects.

FIG. 12C is a flowchart for a method for manufacturing a turbine engine, in accordance with some aspects.

FIG. 13 is a table of test results for the turbine engine, in accordance with some aspects.

FIG. 14A-14E show a turbine engine configured as a generator, all in accordance with some aspects.

FIG. 15A is a perspective view of a turbine engine on a hybrid vehicle, in accordance with some aspects.

FIG. 15B is a front view of a turbine engine on a front portion of a hybrid vehicle, in accordance with some aspects.

FIG. 15C is a close-up top view of a turbine engine on a front portion of a hybrid vehicle as shown in FIGS. 15A and 15B, in accordance with some aspects.

FIGS. 16A and 16B illustrate, respectively, a perspective view and a top view of a plurality of turbine engines arranged for a hybrid heavy-duty vehicle, both in accordance with some aspects.

### DETAILED DESCRIPTION

The present disclosure relates to a turbine engine designed for high efficiency, compact packaging, and reduced component complexity. A turbine rotor of the turbine engine includes hollow spherical blades mounted at the ends of radial spokes extending from a central hub. Each blade includes a strategically positioned opening that receives a working fluid and directs it tangentially to impart rotational motion. In some examples the opening is a sector-shaped cutout in a portion of the spherical shell, the cutout extending circumferentially around the blade and spanning an angular range. In some examples the angular range is approximately 120°. In some examples, the opening of each blade comprises a tapered cutout on the spherical shell. The cutout has a first end width that differs from a second end width such that the cutout transitions in size along its length. In some examples, each blade may include an internal baffle positioned within the hollow spherical shell adjacent to the cutout. The baffle may include an air hole configured to vent or equalize pressure within the blade. These configurations enable efficient capture and redirection of combustion gases or steam, reducing turbulence and improving torque generation.

The turbine rotor is enclosed within a housing that defines an interior cavity for smooth rotation and includes an inlet for directing working fluid and an exhaust pipe for discharging residual gases. The shaft coupled to the turbine rotor may be oriented along a vertical axis or a horizontal axis and is adaptable for connection to a motor, generator, transmission, wheel assembly, propeller, power conversion or propulsion system, enabling integration into systems such as hybrid vehicles, modular power generation systems, and propulsion platforms.

In some aspects, the turbine engine may operate using combustion gases generated within an external chamber, while in other aspects, it may utilize externally supplied steam as the working fluid. Employing a common design architecture that accommodates either combusted gases or steam provides significant versatility, enabling the turbine engine to be deployed across automotive, industrial, and renewable energy applications without major structural modifications.

Unlike conventional internal combustion engines, the disclosed turbine engine eliminates the need for water cooling, engine oil, or a dedicated starter motor, and can be paired with an axial flux motor to form a hybrid powertrain architecture that improves fuel efficiency and power density. These structural and functional features, including the internal cavity of the housing, blade cutout geometry, turbine rotor assembly, and associated operating methods, deliver scalable solutions for diverse powertrain and energy systems.

The blades of the turbine rotor include openings such as cutouts that are shaped to efficiently capture the working fluid during rotation, minimizing turbulence and directing the fluid inward for optimal intake. Once inside, the interior cavity of the housing provides a controlled space that temporarily retains the working fluid, allowing pressure to stabilize and flow to align with system dynamics. This containment enhances energy transfer and ensures that the working fluid is vented smoothly and effectively through the exhaust path, improving overall operational efficiency. The blade geometry further concentrates kinetic energy for stronger actuation of the shaft, absorbs high-pressure air input more effectively, and mitigates back pressure from being applied to the rotating shaft, reducing mechanical stress and improving performance consistency compared to conventional designs. Additionally, the turbine blades rotate within a closed housing, where airflow is guided in the direction of rotation until it reaches the exhaust pipe. These design elements collectively improve the efficiency of the turbine engine significantly.

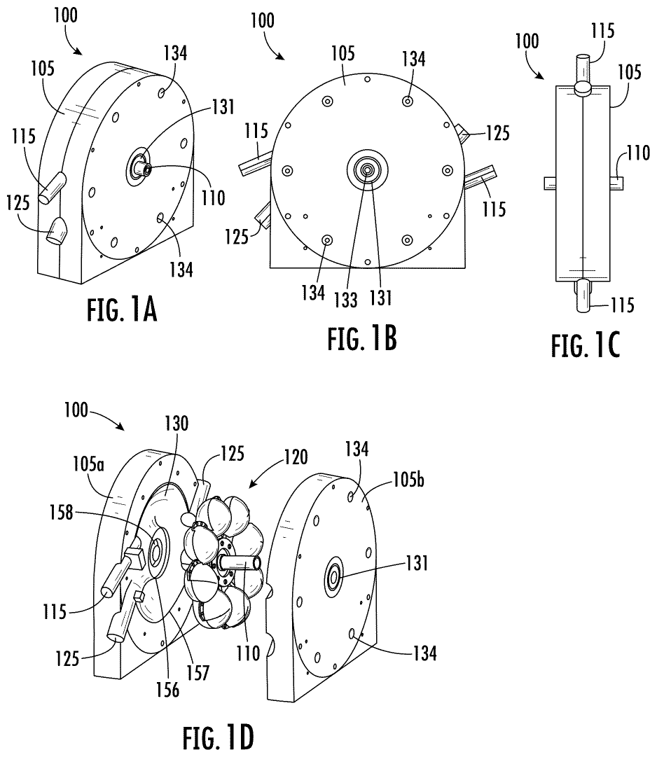

FIG. 1A is a perspective view of a turbine engine, FIG. 1B is a front view of a turbine engine, FIG. 1C is a side view of a turbine engine, and FIG. 1D is an exploded view of a turbine engine shown in FIGS. 1A-1C, all in accordance with some aspects. A turbine engine 100 may include a housing 105 with a shaft 110 mounted centrally and extending axially through the housing 105. The shaft 110 may be defined as an elongated, cylindrical member configured to transfer mechanical energy generated by the turbine rotor 120 to an external load or coupled system. An inlet 115 is coupled to the housing 105 and is configured to direct a working fluid into the interior of the housing 105. The working fluid may include steam, combustion gases from fossil or renewable fuels, compressed air, or other suitable pressurized gases capable of driving a turbine rotor. The working fluid is directed into the housing 105 to drive a turbine rotor 120 mounted to the shaft 110. Residual gases or exhaust gases may be expelled from the housing 105 by an exhaust pipe 125 coupled to the housing 105. The turbine engine 100 may include more than one inlets 115 and/or more than one exhaust pipes 125.

In some implementations, the housing 105 of the turbine engine 100 may define an interior cavity 130 having a toroidal shape configured to accommodate rotation of the turbine rotor 120. The interior cavity 130 has an inner wall 156 (central ring of the toroid) and an outer wall 157 (outer diameter of the toroid). In some examples, the housing 105 may be formed from two halves. In this configuration, the housing 105 includes a first enclosure 105a and a second enclosure 105b as shown in FIG. 1D. The first enclosure 105a and the second enclosure 105b may be integrally formed with the inlet 115 and the exhaust pipe 125. In this context, integrally formed means that the inlet 115 and the exhaust pipe 125 are manufactured as a single continuous structure with the housing rather than as separate components joined later. In some examples, the first enclosure 105a may define the interior cavity 130, and the second enclosure 105b may serve as a cover for the first enclosure 105a to complete the housing 105. In some examples, an O-ring may be positioned along the inner wall 156 and/or outer wall 157 to help prevent leakage from the housing 105.

The turbine rotor 120 further includes a hub 131 configured to couple to the shaft 110. The hub includes a thrust ball bearing 133 in channel 158 disposed between the turbine rotor 120 and the housing 105 to reduce rotational friction, and stabilize the shaft 110 during high-speed operation for smooth and efficient turbine performance.

In some implementations, the housing 105 may further include mounting holes 134 spaced circumferentially around its outer surface. The mounting holes 134 may be used to couple the turbine engine 100 to another turbine engine or to secure the housing 105 to a flat surface or other structural support. In FIGS. 1A, 1B and 1D, only some mounting holes 134 are labeled for clarity.

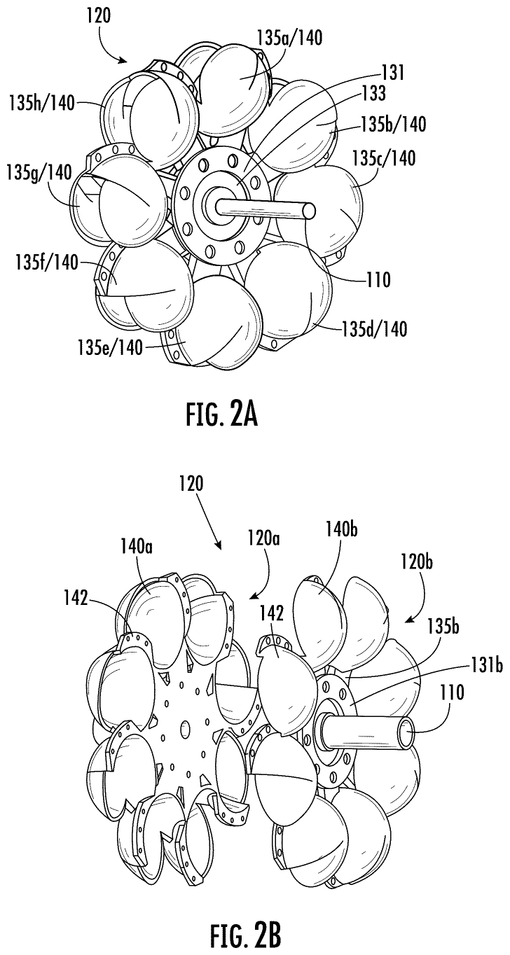

FIG. 2A is a perspective view of a turbine rotor, in accordance with some aspects. The turbine rotor 120 includes a plurality of spokes 135 extending radially outward from the hub 131. Each spoke 135 terminates in a blade 140 positioned at a distal end, and a plurality of blades is arranged symmetrically around the hub. In some examples, each blade 140 has a diameter in the range of 155 mm to 165 mm, or 160 mm, and a width or thickness in the range of 45 mm to 55 mm, or 50 mm. In the illustrated example, eight spokes 135a-135h are shown, corresponding to an 8-blade turbine rotor configuration. The spokes 135 may each have an equal length, with the length being selectable or adjustable to accommodate a particular application.

FIG. 2B is an exploded view of a turbine rotor of FIG. 2A, in accordance with some aspects. The turbine rotor 120 may be formed from two halves, 120a and 120b, that are joined together during manufacturing. For example, the turbine rotor 120 may include a first turbine rotor half 120a and a second turbine rotor half 120b. Each turbine rotor half includes a hub segment 131a (not shown) or 135b configured to couple to the shaft 110 about an axis of rotation. A plurality of spokes 135a (not shown) or 135b extend radially outward from the respective hub segments. At the distal end of each spoke, a blade half-shell 140a or 140b is provided, with each blade half-shell positioned to mate with a corresponding blade half-shell of the other turbine rotor half so that, when coupled, the mated blade half-shells define a blade 140.

Each blade half-shell 140a and 140b may include a tab 142a or 14b configured to receive fasteners. The fasteners secure the blade half-shells 140a and 140b together, thereby coupling the first turbine rotor half 120a and the second turbine rotor half 120b to form the turbine rotor 120. In contrast, other types of turbine engines, such as steam turbine engines, may incorporate numerous components and subassemblies, often involving multiple stages of blades, seals, and casings. Such designs increase mechanical complexity, manufacturing cost, and assembly time. In some examples, adjacent blades 140 of a plurality of blades may be interconnected to form a continuous aerodynamic surface. This configuration helps reduce turbulent airflow between the blades 140, minimizes energy dissipation during rotation, and preserves pressure differentials across the plurality of blades.

Referring to the exploded views of FIGS. 1D and 2B, the turbine engine 100 may include the housing 105 (e.g., two halves), the turbine rotor 120 (e.g., the first turbine rotor half 120a and the second turbine rotor half 120b), an inlet 115, and a shaft 110. The systems and methods herein provide a simplified configuration that reduces part count, facilitates efficient manufacturing, and streamlines assembly of the turbine engine 100 compared to conventional turbine engines. Referring to FIGS. 1A-2B, the housing 105 of the turbine engine 100 defines an interior cavity 130 or tunnel. The interior cavity 130 of the housing 105 comprises an annular passage having a toroidal shape. The annular passage is dimensioned to accommodate the turbine rotor 120 and the plurality of blades within the annular passage.

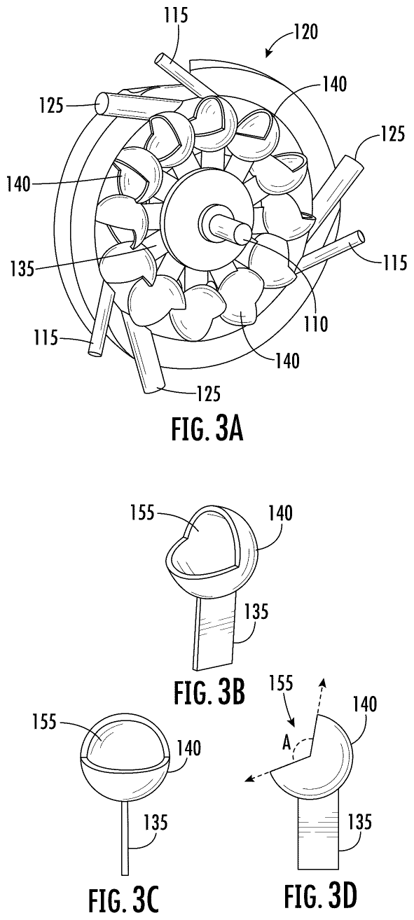

A shaft 110 extends axially through the housing 105. A turbine rotor 120 is coupled to the shaft 110. The turbine rotor 120 includes the hub 131 configured to couple to the shaft 110. A plurality of spokes 135 extend radially outward from the hub 131. A plurality of blades is included and each blade 140 is disposed at a distal end of a corresponding spoke 135 and shaped as a hollow spherical shell having an opening 155 or chamber (FIG. 3B). The opening 155 is oriented to receive a working fluid and direct the working fluid tangentially to impart rotational motion to the turbine rotor 120. An inlet 115 is coupled to the housing 105 and configured to direct the working fluid into the interior cavity 130 of the housing 105 and into the opening 155 of the blade 140. An exhaust pipe 125 is configured to discharge residual gases from the housing 105.

FIG. 3A is a perspective view of a turbine engine with a portion of the enclosure removed, FIG. 3B is a perspective view of a blade, FIG. 3C is a front view of a blade, and FIG. 3D is a side view of a blade, all in accordance with some aspects. The blade 140 is positioned at a distal end of each spoke 135 may be shaped as a hollow spherical body or shell. For clarity of illustration, only certain reference numerals for spokes 135 and blades 140 are shown; however, it will be understood from the figures that each distal end of a spoke 135 includes a blade 140. A cutout portion of the spherical body creates an aperture or opening 155 configured to receive gases from the inlet 115. In some examples, the opening 155 of each blade 140 comprises a sector-shaped cutout or a wedge-shaped sector in a portion of the spherical shell. The opening 155 extends circumferentially around the blade 140 and spans an angular range A. In some examples the angular range is in the range of 115° to 125°, or approximately 120° of the sphere's circumference. The opening 155 defines a concave recess that conforms to the curvature of the spherical shell. The opening 155 is perpendicular to the longitudinal axis of the blade 140.

Put another way, each blade 140 may be shaped as a hollow spherical shell with a sector removed to define the opening 155. The opening 155 is oriented such that, during operation, the concave, bowl-like recess faces in a direction to receive and interact with the flow of the working fluid from the inlet 115 within the interior cavity 130 of the housing 105. The blade 140 may be a hemispherical cup incorporating a 120° opening. The geometry of the opening 155 is configured to direct the thrust force tangentially relative to the axis of rotation. The curved cutout of opening 155 is shaped to capture and redirect combustion gases, enabling the blade 140 to efficiently convert the momentum of the working fluid into rotational motion. By conforming to the sphere's curvature, the opening 155 provides a continuous, concave surface for the incoming gases, which enhances the capture and redirection of the combustion gases and maximizes the transfer of energy to the turbine rotor during operation.

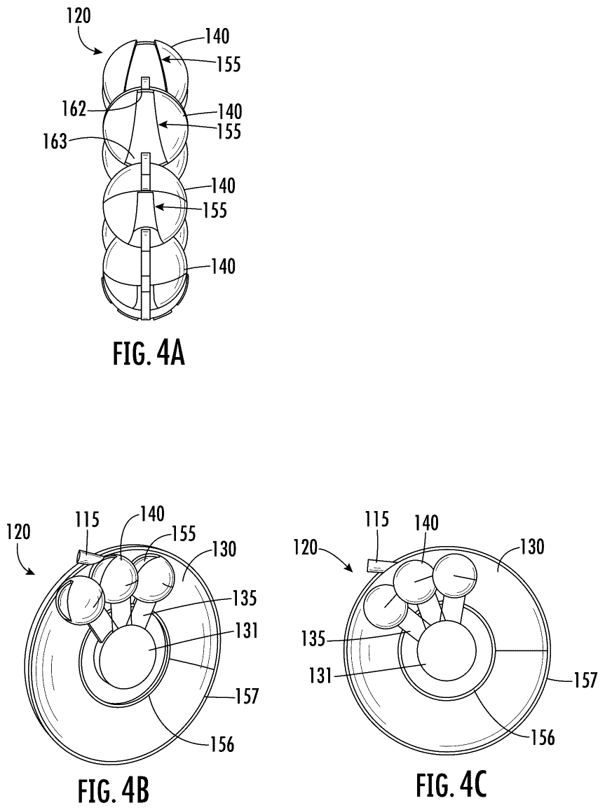

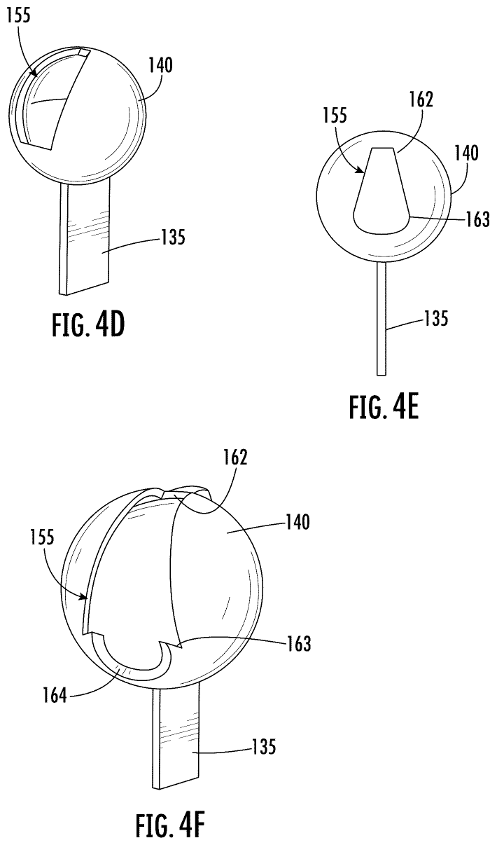

FIG. 4A is a side view of a turbine rotor, FIG. 4B is a perspective view of a portion of the turbine rotor in the tunnel, and FIG. 4C is a side view of a portion of the turbine rotor in the annular tunnel, all in accordance with some aspects. FIG. 4A depicts the blade 140, including the opening 155, in various positions corresponding to the rotation of the turbine rotor 120. The description of the blade 140 and the opening 155 is consistent with that provided with reference to FIGS. 3A-3D, with the variation that the opening 155 is formed in a different shape in this example.

FIGS. 4B and 4C depict a portion of the turbine rotor 120 within interior cavity 130 of housing 105 for clarity. The interior cavity 130 of the housing 105 defines an annular passage, tunnel, or donut having a toroidal geometry. The interior cavity 130 has an inner wall 156 and an outer wall 157, and each blade 140 of the plurality of blades is configured to travel through the annular passage of the interior cavity 130 between the inner wall 156 and the outer wall 157. For example, during rotation of the turbine rotor 120, each blade 140 traverses the passage along a path defined by the toroidal shape. Put another way, the interior cavity 130 of the housing 105 defines an annular passage having a toroidal shape, and each blade 140 of the plurality of blades passes through the passage during rotation.

The orientation of blade 140 is positioned so that the opening 155 is able to receive working fluid from inlet 115. In some examples, the opening 155 in each blade 140 is oriented circumferentially around the blade 140, with the concave recess defined by opening 155 closely conforming to the curvature of interior cavity 130. This configuration allows the edge of opening 155 to be adjacent to the outer wall 157 of the interior cavity 130 so that the blade 140 is guided by interior cavity 130 as it rotates. As the blade 140 rotates within the interior cavity 130, the concave recess of opening 155 remains aligned with the curvature of the interior cavity 130. This arrangement ensures that the blade 140 maintains a stable, conforming interface with interior cavity 130 throughout its range of motion, promoting efficient transfer of force from the working fluid and reliable guidance of the blade 140 during operation.

FIGS. 4D and 4F are perspective views of a blade, and FIG. 4E is a front view of a blade, all in accordance with some aspects. In some implementations, the opening 155 in the body of the blade 140 is an elongated, concave cutout on the spherical body of the blade 140. The opening 155 of each blade 140 comprises a tapered cutout on the spherical shell. The cutout (e.g., opening 155) has a first end width 162 that differs from a second end width 163 such that the cutout transitions in size along its length.

The opening 155 may be an irregularly shaped strip cut from the blade 140. The opening 155 transitions in width along its length, beginning with a dimension that, in some examples, corresponds to the diameter of the inlet 115 and gradually widening or narrowing to align with the diameter of the exhaust pipe 125. In this example, the opening 155 widens to align with the diameter of the exhaust pipe 125. This tapered configuration acts as a flow-conditioning feature: the narrower entry region promotes efficient capture of high-pressure working fluid from the inlet 115, while the opposite end, which widens, accelerates the expulsion of residual gases toward the exhaust pipe 125. By directing airflow in a controlled manner, the opening 155 enhances energy transfer to the rotating blades, reduces turbulence, and minimizes backflow.

The opening 155 on the outer surface of the spherical body of the blade 140 and may be an elongated, tapered cutout with a generally curved profile. It extends along a portion of the sphere's surface following an arc-like path that conforms to the curvature of the spherical body. The opening 155 extends along a longitudinal direction of the blade 140 and has a length greater than its width. The opening 155 is oriented to receive thrust gases from the inlet 115 and to direct the gases tangentially relative to the turbine rotor 120 to impart rotational motion.

FIG. 4F is a perspective view of a blade, in accordance with some aspects. A lower boundary 164 of the opening 155 of the blade 140 may include further features such as a curved portion that forms a smooth transition between the interior of the cutout and the surrounding surface of the spherical body of the blade 140. This curved portion may be an arc shaped feature that follows the contour of the spherical body to further align with the diameter of the exhaust pipe 125. In other implementations, the lower boundary 164 of the opening 155 may have different geometries, such as a straight edge, a chamfered edge, or a compound curve.

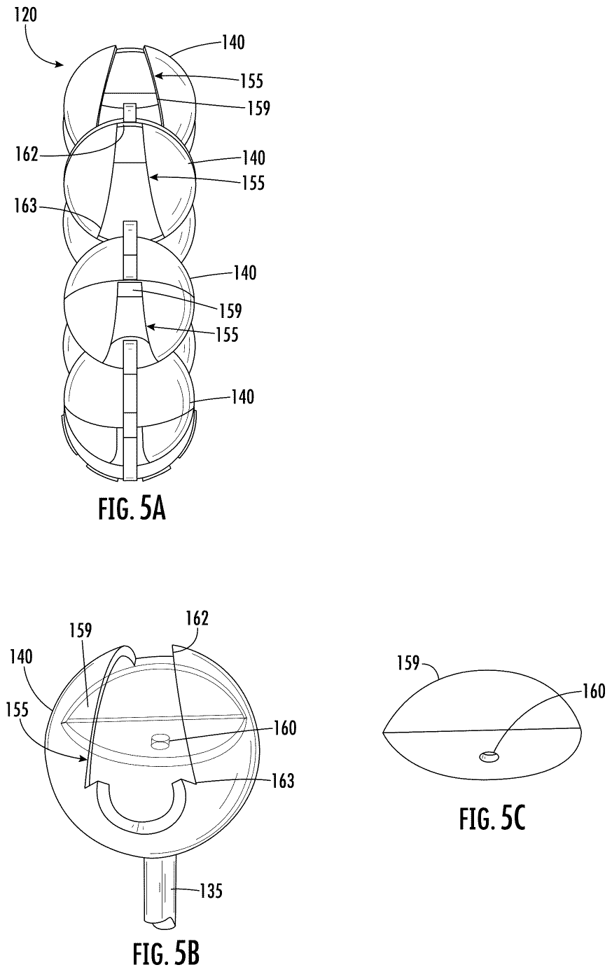

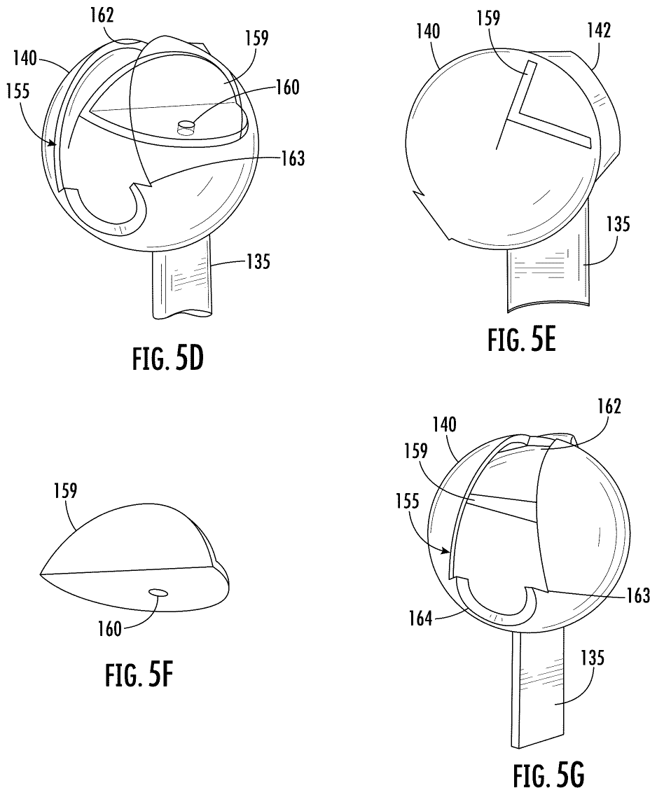

FIG. 5A is a side view of a turbine rotor, in accordance with some aspects. The turbine rotor 120 includes blades 140, and each blade 140 includes an opening 155. The description of the blade 140 and the opening 155 is similar to that provided with reference to FIGS. 4A-4F. In this example, the blade 140 also includes a baffle 159 coupled to the blade's interior body and configured to partially obstruct and redirect thrust gases entering the blade 140 from the inlet 115.

FIGS. 5B and 5C illustrate, respectively, a perspective view of a blade including a baffle and a perspective view of the baffle itself, both in accordance with some aspects. FIGS. 5D-5F depict, respectively, a perspective view of a blade including a baffle, a side view of a blade including a baffle, and a perspective view of the baffle itself, all in accordance with some aspects. FIG. 5G is a perspective view of a blade including a baffle. As shown, the baffle 159 may be integral with or affixed to the interior surface of the blade 140. The baffle 159 may be configured as L-shaped with approximately a 90° angle and positioned as a curved partition extending along the inner surface of the blade 140. In some aspects, the baffle 159 may function to redirect or modulate the flow of gases entering through the opening 155, thereby enhancing thrust efficiency and rotational control. The baffle 159 may also serve to isolate flow paths within the blade 140, promoting directional thrust and reducing turbulence. Unlike conventional blade designs that rely solely on shell geometry, the inclusion of baffle 159 provides an internal flow control mechanism that improves performance without increasing part count (when integral with blade 140) or assembly complexity.

The baffle 159 may be positioned in different orientations within the interior of the blade 140. FIG. 5B shows the baffle 159 positioned with the interior of the L-shape facing the opening 155. In some examples, the interior of the L-shape of the baffle 159 faces the first end width 162 of the opening 155, or the top of the opening 155. FIG. 5D shows the baffle 159 positioned with the interior of the L-shape facing an interior wall of the blade 140 or rotated approximately 90° from the position shown in FIG. 5B. FIG. 5G shows the baffle 159 positioned with the interior of the L-shape facing the opening 155. In some examples, the interior of the L-shape of the baffle 159 faces the second end width 163 of the opening 155, or the bottom of the opening 155.

In some embodiments, an air hole 160 may be positioned in the baffle 159 to vent or equalize pressure within the internal cavity of the blade 140. This configuration allows the blade 140 to absorb high-pressure air input more efficiently while preventing back pressure from acting on the rotating shaft 110. By reducing pressure imbalances and mitigating reverse forces, the feature enhances aerodynamic stability and optimizes gas flow through the plurality of blades.

The turbine engine 100 may operate with different power sources and fuels to generate thrust gases that enter the blades 140 of the turbine rotor 120. For example, high-pressure steam may be supplied from an external source, such as a boiler heated by a natural gas pipeline or other energy source, to drive the turbine rotor 120. In this way, the turbine engine 100 operates without a combustion chamber. In other implementations, fuel may be combusted in an internal combustion chamber to rotate the turbine rotor 120. Suitable fuels include fossil fuels such as gasoline or diesel, natural gas, methane, propane, biofuels, and hydrogen, among others. In some cases, renewable or synthetic fuels may also be employed, providing additional flexibility in adapting the turbine engine 100 to various operating environments and energy infrastructures.

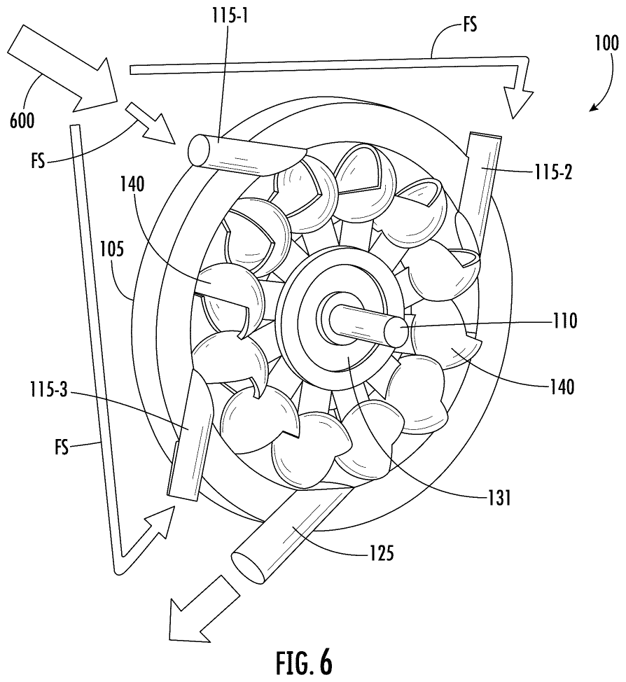

FIG. 6 is a perspective view of a turbine engine with a portion of the housing removed, in accordance with some aspects. In some implementations, high-pressure steam is supplied to drive turbine rotor 120. The turbine engine 100 may include any number of inlets 115. In this example, there are three inlets 115 with a single exhaust pipe 125. The exhaust pipe 125 is configured to discharge low-pressure steam after expansion through the turbine stages. Similarly, there may be more than one exhaust pipe 125. In some implementations, each inlet 115 corresponds to an exhaust pipe 125 so that there are the same number of inlets 115 as exhaust pipes 125. For example, the turbine engine 100 may include an equal number of inlets 115 and exhaust pipes 125 positioned in corresponding positions around the housing 105. In some examples, each inlet 115 is paired with an exhaust pipe 125 along the same circumferential segment of the housing to define a paired flow path for working fluid entry and discharge.

To power the turbine engine 100, one or more sources of fluid may be used. In one implementation, a primary high-pressure steam input 600 delivers steam to the inlets 115-1, 115-2 and 115-3, and a fan-out stream FS from input 600 is distributed among the inlets 115-1, 115-2 and 115-3 to achieve balanced flow.

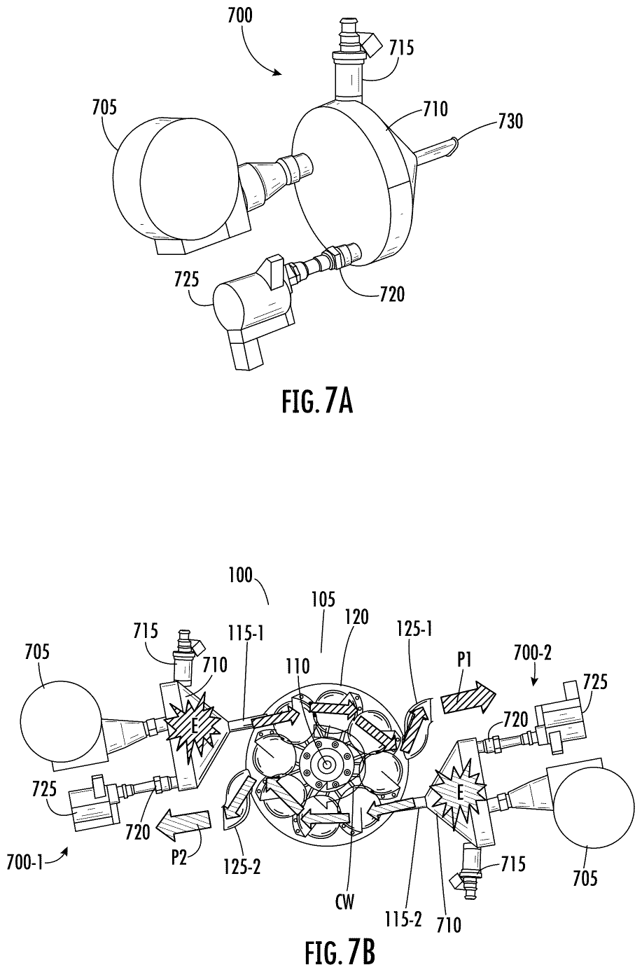

FIG. 7A is a perspective view of a combustion assembly, and FIG. 7B is a front view of a turbine engine with a portion of a housing removed, both in accordance with some aspects. In some implementations, a combustion assembly 700, or multiple combustion assemblies 700-1, 700-2 . . . 700-n may be configured to generate the working fluid supplied to the turbine engine 100. The combustion assembly 700 is coupled to the inlet 115 of turbine engine 100 and provides a chamber in which a fuel and oxidizer mixture is combusted. Combustion gases generated within the assembly are directed into housing 105 through the inlet 115 to drive turbine rotor 120.

The combustion assembly 700 comprises an air injector port 705 configured to supply compressed air to a combustion chamber 710 by, for example, an air compressor or fan. An electronic fuel injector (EFI) 715 introduces fuel into the combustion chamber 710, where the fuel mixes with the compressed air. The combustion chamber 710 may be a conical shape with a first, wider-shaped end and a second, narrower-shaped end such as a funnel. Other shapes are possible. The one or more combustion chambers 710 and may be positioned tangentially around the housing 105 corresponding to inlets 115. A sparkplug 720, energized by a coil 725, ignites the fuel-air mixture to initiate combustion. Combustion gases are expelled through a nozzle 730. The nozzle 730 is configured to couple to the inlet 115 and is shaped to accelerate and direct the gases (e.g., working fluid) toward the blades 140 of the turbine rotor 120 to impart rotational motion to the turbine rotor 120.

In some examples, the turbine engine 100 has an 8-blade turbine rotor configuration with two combustion assemblies 700-1 and 700-2. Upon ignition, the fuel-air mixture within the combustion chamber 710 produces an explosion (labeled E). The resulting hot gases flow from the combustion assembly 700 through the nozzle 730 and into the housing 105, where they impinge upon the blades 140 of the turbine rotor 120, thereby causing rotation of the turbine rotor 120. In this example, the rotation is in a clockwise direction (arrow labeled CW) about the shaft 110. Exhaust gases exiting the turbine rotor 120 may be discharged from the housing 105 via exhaust pipes 125-1 and 125-2. A flow path generated by a first combustion assembly 700-1 is designated as P1, and a flow path generated by a second combustion assembly 700-2 is designated as P2.

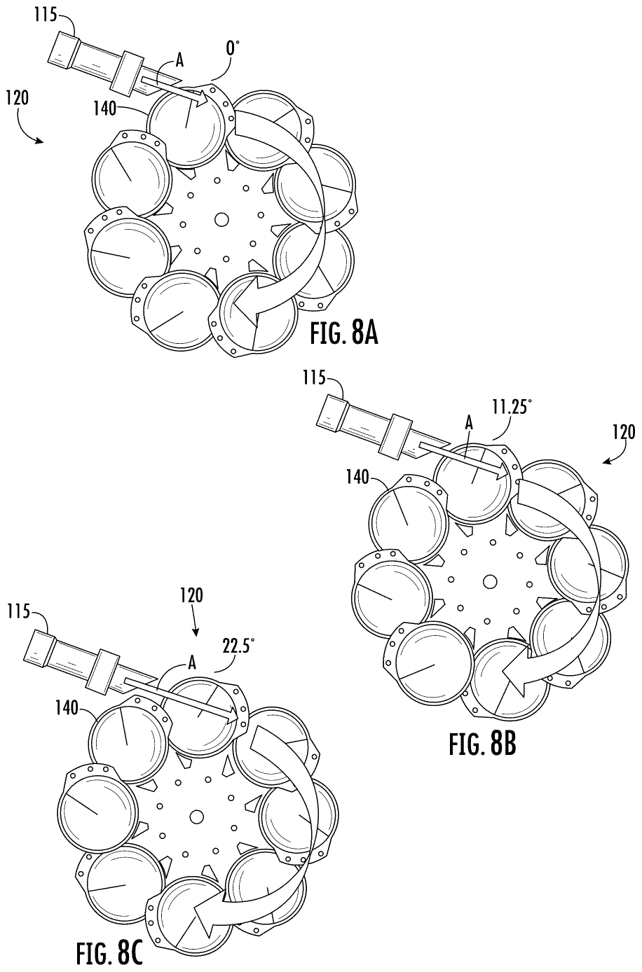

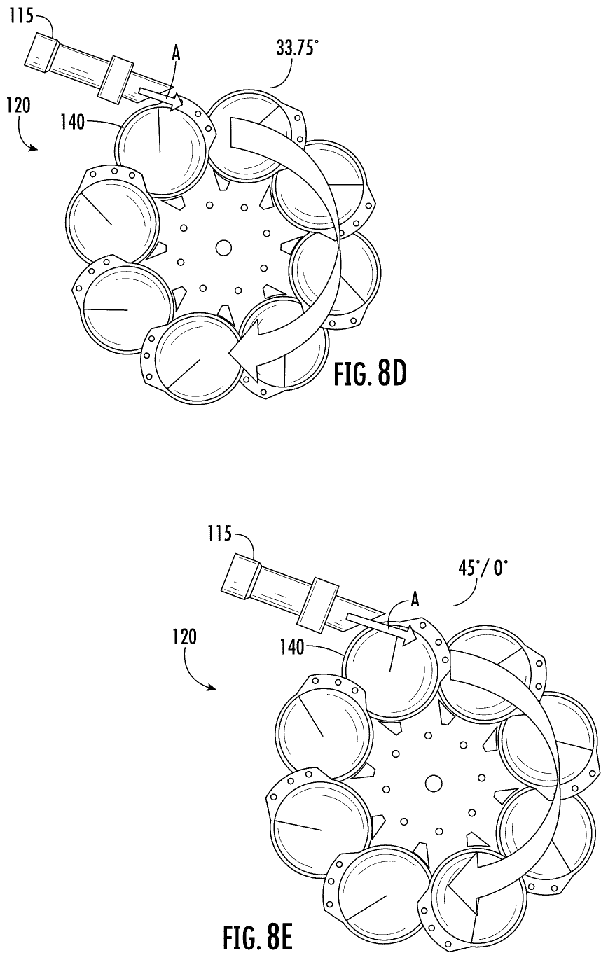

FIGS. 8A-8E depict blades of the turbine rotor in various orientations, in accordance with some aspects. The blade 140 of the turbine rotor 120 may be positioned at varying angles relative to the incoming working fluid from the inlet 115 to optimize energy transfer and torque generation. The blade 140 orientation can range from approximately 0°, where the blade 140 aligns with the flow direction (arrow labeled A), to progressively offset positions such as about 11.25°, 22.5°, 33.75° and 45° which is the same position as 0°. In other aspects, the progressively offset positions may be 10°-13°, 21°-24°, 32°-35° and 44°-46°. The blade 140 orientation effectively redirects the flow toward the initial reference direction, creating a cyclical pattern of angular adjustment. These incremental variations in blade angle allow fine-tuning of rotor performance for different operating conditions, improving efficiency and adaptability of the turbine engine 100.

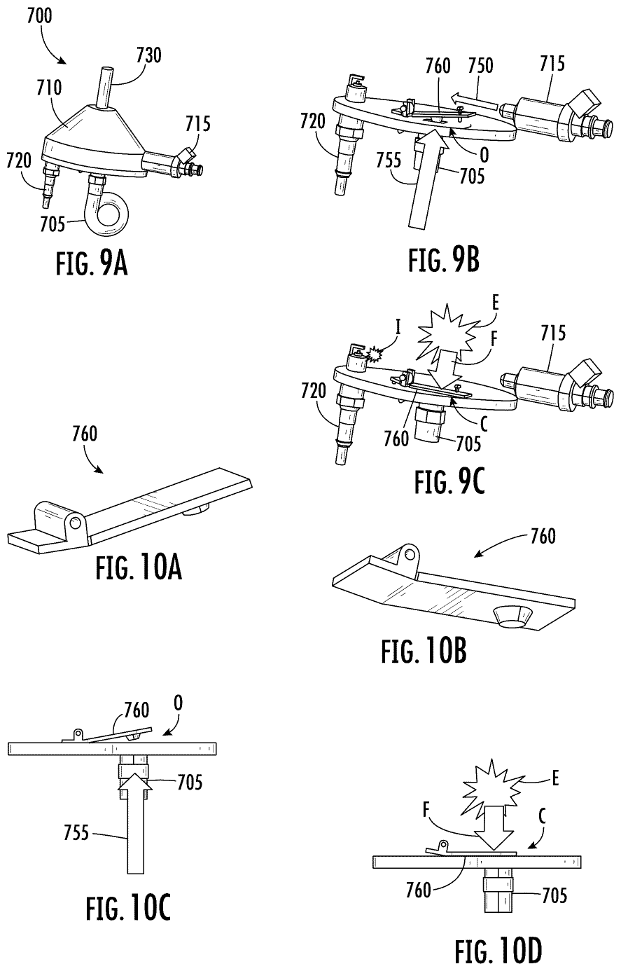

FIG. 9A is a perspective view of a combustion assembly, and FIGS. 9B and 9C are perspective views of a combustion assembly with the combustion chamber removed, all in accordance with some aspects. FIG. 10A is a perspective view of an air intake valve of the combustion chamber in an open position, FIG. 10B is a perspective view of an air intake valve of the combustion chamber in a closed position, and FIGS. 10C and 10D are side views of a combustion assembly with the combustion chamber removed, all in accordance with some aspects.

During operation, the EFI 715 dispenses high-pressure fuel 750 (FIG. 9B), and the air compressor or fan supplies high-pressure air 755 into the combustion chamber 710 (removed and not shown for this illustration) via the air injector port 705. The high-pressure air 755 may also serve a cooling function, circulating around the annular passage of interior cavity 130 of the housing 105 to assist in dissipating heat from the turbine engine 100. In addition, the high-pressure fuel 750 delivered by the EFI 715 can provide a cooling effect to the combustion assembly 700.

Referring to FIGS. 9B, 10A and 10C, while the EFI 715 sprays high-pressure fuel 750 and high-pressure air 755 is introduced into the combustion assembly 700 through the air injector port 705, an air intake valve 760 is forced into an opened position (labeled O) by the pressure of the incoming air 755. Referring to FIGS. 9C, 10B and 10D, ignition of the fuel-air mixture is shown. For example, a sparkplug 720 ignites (labeled I) the fuel-air mixture within the combustion chamber 710, causing an explosion (labeled E). The resulting explosion force (labeled F) drives the air intake valve 760 into a closed position (labeled C).

It will be understood that the turbine engine 100 may include any suitable number of blades 140 and any suitable number of inlets 115 for power sources (e.g., high-pressure steam 600, combustion assemblies 700, etc.) depending on the application. In some aspects, the turbine engine 100 may include one or more combustion assemblies 700 and one or more exhaust pipes 125. In some aspects, the number of exhaust pipes 125 corresponds to the number of inlets 115.

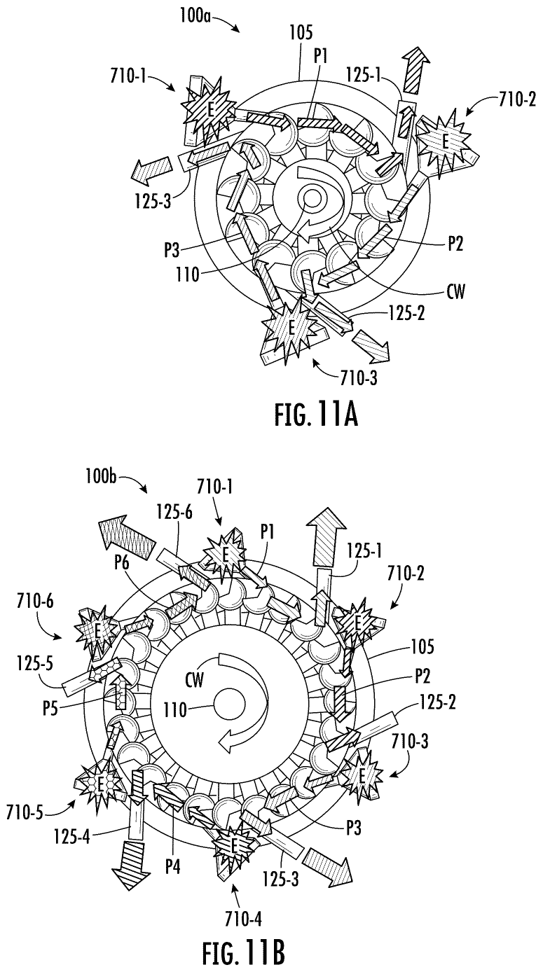

FIGS. 11A and 11B are front views of a portion of the turbine engine with a portion of a housing removed, both in accordance with some aspects. In the examples illustrated in FIGS. 11A and 11B, only the combustion chambers 710 (e.g., 710-1, 700-2 . . . 710-n) of the combustion assemblies 700 (e.g., 700-1, 700-2 . . . 700-n) are shown coupled to turbine engines 100a and 100b, respectively, for clarity of illustration. FIG. 11A depicts a turbine engine 100a having a 12-blade turbine rotor configuration with three combustion assemblies 700, and FIG. 11B illustrates a turbine engine 100b having a 24-blade turbine rotor configuration with six combustion assemblies 700. The respective flow paths extending from each combustion assembly 700 to the turbine rotor 120 and subsequently to the corresponding exhaust pipe 125 are identified as P1, P2 . . . Pn. The number of blades 140 may be changed by adjusting the diameter of the housing 105 and/or the size of the blades 140.

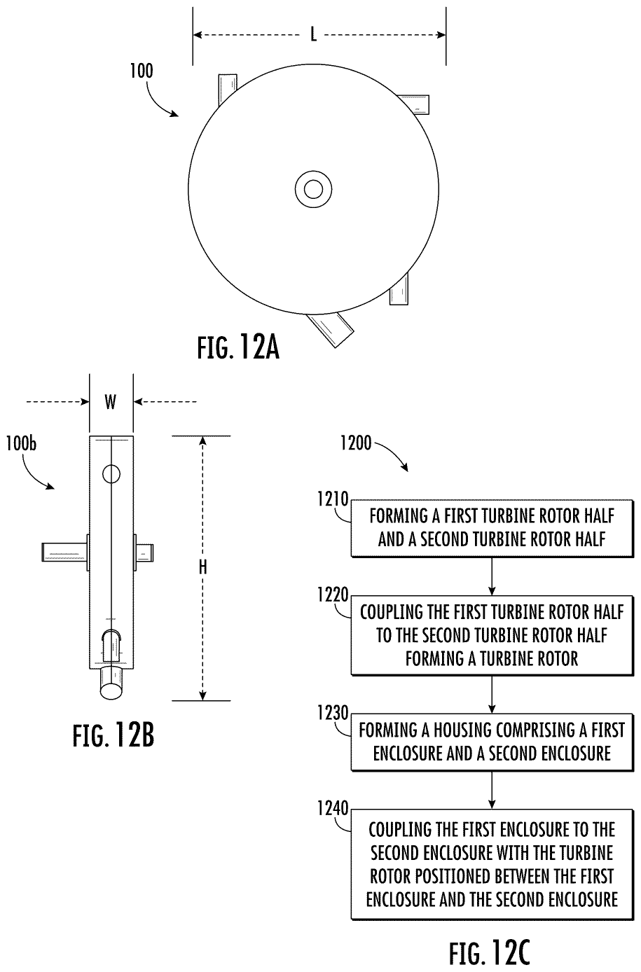

FIG. 12A is a front view of a turbine engine, and FIG. 12B is a side view of a turbine engine, both in accordance with some aspects. The turbine engine 100 is compact and in some aspects, may have a length (L) in a range of 30 cm to 90 cm, a height (H) in a range of 30 cm to 90 cm, and a width (W) in a range of 6 cm to 15 cm.

The turbine engine 100 is configured for efficient, high-volume manufacture. Conventional turbine engines typically require numerous precision components in the rotor blade system, and the large size of the engine housing can render high-volume production impractical. In contrast, the present design enables cost-effective manufacturing using die-casting techniques for the turbine rotor 120 and/or the housing 105. In alternative embodiments, the turbine rotor 120 can be formed by sheet-metal stamping, permitting rapid fabrication at significantly reduced cost relative to traditional approaches.

In some examples, a hot-chamber die-casting process may be employed to manufacture the turbine engine 100. Molten metal is maintained in a heated reservoir and, during each cycle, is injected under high pressure into a mold cavity to fill fine features. After solidification, the mold opens and the casting is removed. This approach supports production of precise components in large quantities, combining short cycle times with good dimensional control.

FIG. 12C is a flowchart for a method for manufacturing a turbine engine, in accordance with some aspects. The particular steps, order of steps, and combination of steps are shown for illustrative and explanatory purposes only. Other aspects can implement different particular steps, orders of steps, and combinations of steps to achieve similar functions or results. A method 1200 for manufacturing a turbine engine begins at block 1210 by forming a first turbine rotor half and a second turbine rotor half. Each turbine rotor half includes a hub segment configured to couple to a shaft about an axis of rotation. A plurality of spokes extends radially outward from the hub segment. A plurality of blade half-shells is at a distal end of a corresponding spoke. Each blade half-shell is positioned to mate with a corresponding blade half-shell of the other turbine rotor half. When the first turbine rotor half and the second turbine rotor half are coupled together, each mated blade is shaped as a hollow spherical shell having an opening. The opening is oriented to receive a working fluid and direct the working fluid tangentially to impart rotational motion to the turbine rotor.

At block 1220, the first turbine rotor half is coupled to the second turbine rotor half forming a turbine rotor. At block 1230, a housing is formed comprising a first enclosure and a second enclosure. The housing is also integrally formed with an inlet and an exhaust pipe. At block 1240, the first enclosure is coupled to the second enclosure with the turbine rotor positioned between the first enclosure and the second enclosure. A thrust ball bearing is positioned between the housing and the turbine rotor.

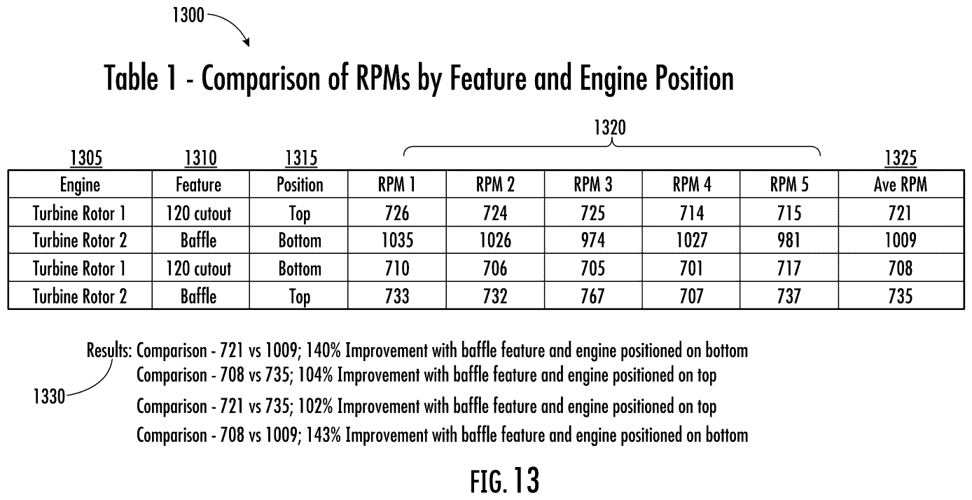

FIG. 13 is a table of test results for the turbine engine, in accordance with some aspects. Trials were conducted on the turbine engine in multiple configurations, and the rotational speeds (revolutions per minute, RPM) for each configuration were recorded. Table 1300 summarizes the results for turbine rotor 1 (turbine engine 1) and turbine rotor 2 (turbine engine 2), as indicated in column 1305. Column 1310 identifies design features such as a blade with a hemispherical cup incorporating a 120° opening (“120 cutout”) or a blade with an opening and incorporating a baffle (“baffle”). For these tests, turbine engine 1 and turbine engine 2 were arranged in a stacked configuration on a common shaft (e.g., shaft 110) in a vertical orientation (with turbine engines lying horizontal). Column 1315 specifies which turbine engine occupied the top position. Column 1320 lists the RPM values recorded across five trials, and column 1325 provides the calculated average RPM for those trials. Comparison results 1330 are listed.

Comparative testing was performed on turbine engines in stacked configurations to evaluate the effect of blade design and positional arrangement on rotational performance. Results indicate that incorporating a baffle feature within the blade significantly improves rotational speed (RPM) compared to a hemispherical cup design with a 120° opening. For example, when the engine with the baffle feature was positioned on the bottom, RPM increased from approximately 721 to 1009, representing an improvement of about 140% vs. the 120° cutout design stacked on top. Similarly, when the baffle-equipped engine was positioned on the top, RPM improvements ranged from approximately 708 to 735 (about 104%) compared to the 120-cutout design stacked on the bottom; and from 721 to 735 (about 102%) when comparing the 120° cutout design on top to the baffle design on top. In another comparison, positioning the baffle-equipped engine on the bottom yielded an increase from 708 to 1009 RPM compared to the 120° cutout design on the bottom, corresponding to an improvement of approximately 143%. These results demonstrate that blade geometry and positional arrangement influence performance, with the baffle feature providing substantial efficiency gains. It is noted that the configuration incorporating a 120° cutout demonstrated consistently strong performance, underscoring its viability as an alternative design. This configuration may be selected where design simplicity or specific geometric constraints make it preferable. Additional testing shows that a vertical shaft configuration delivers, on average, approximately 12.6% greater power output compared to a horizontal shaft configuration under otherwise identical conditions. This improvement is attributed to the enhanced balance and reduced gravitational load effects associated with vertical-axis rotation.

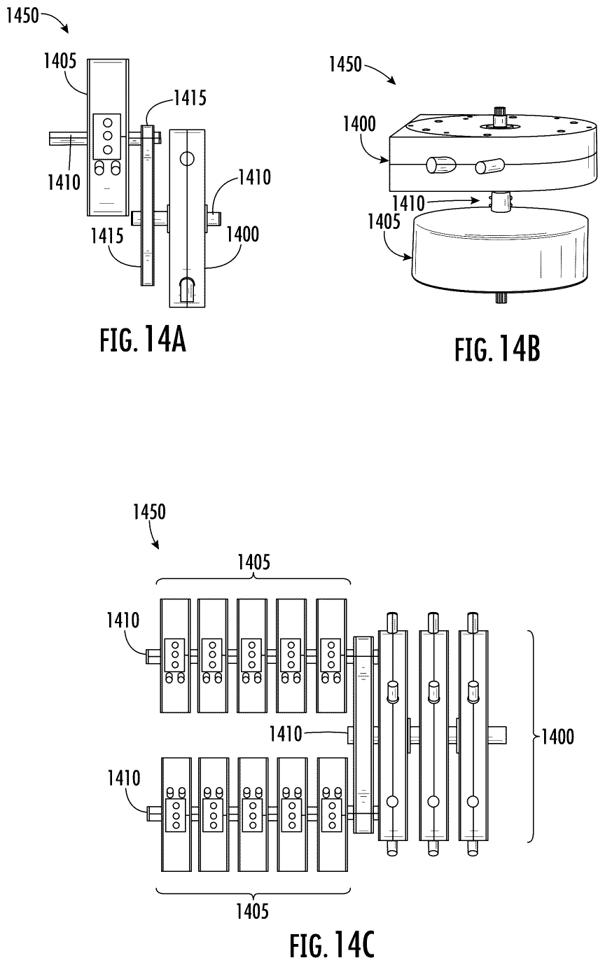

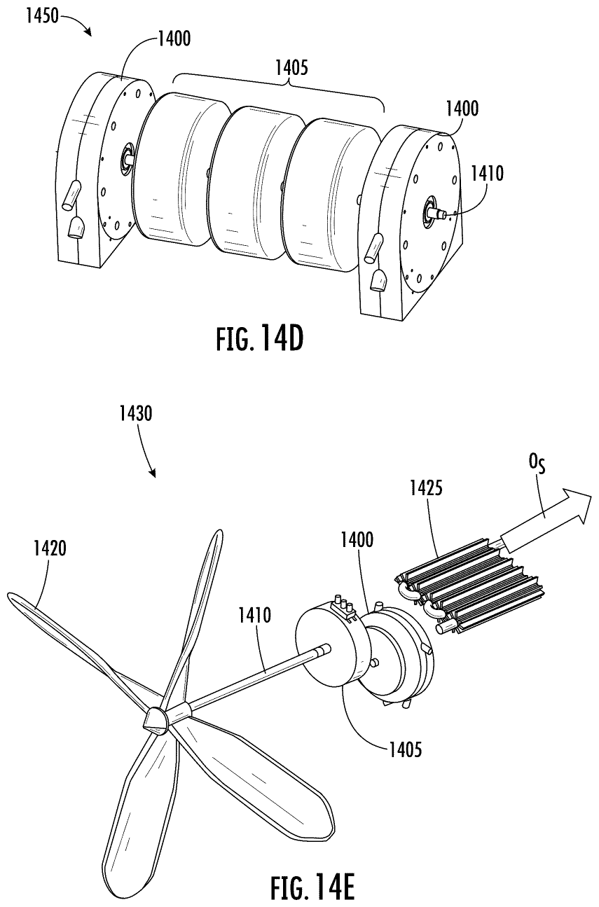

FIG. 14A-14D show a turbine engine configured as a generator, all in accordance with some aspects. A turbine engine 1400 may be coupled to one or more axial flux motors 1405 via a shaft 1410 to form a generator 1450. The shaft 1410 may be oriented along a horizontal axis (FIG. 14A) or along a vertical axis (FIG. 14B), providing flexibility for installation in different system configurations. In some implementations, the turbine engine and axial flux motor share a common continuous shaft 1410 as shown in FIG. 14B, creating a co-shafted arrangement that minimizes mechanical losses and enables a compact assembly. In other implementations, the components may employ separate shafts 1410 connected through an intermediate coupling or gearbox 1415 as shown in FIG. 14A to accommodate alignment or torque requirements. Both configurations enable efficient transfer of rotational energy from the turbine engine to the axial flux motor for electricity generation.

Conventionally, turbine engines and generators are configured with a horizontal shaft. In some examples, the disclosed system may employ either a horizontal or vertical shaft orientation. A vertical-axis rotating assembly may provide more balanced rotational motion than a horizontal-axis assembly, particularly under heavy loads where gravitational effects influence stability. This flexibility in shaft orientation enables optimization of performance for different installation environments.

In some examples, when steam is employed as the working fluid, the turbine engine 1400 is configured similarly to a conventional turbine but operates without a combustion chamber, relying instead on high-pressure steam to drive the rotor. High-pressure steam drives a turbine rotor coupled to one or more alternators to generate electricity. The turbine engine 1400 may be integrated with one or more axial flux motors 1405 to form a compact, high-power-density generator 1450. This configuration can include an inlet and provide a standard alternating current output, such as three-phase 277/480 volts at 50 to 60 hertz, along with a residual low-pressure steam output. The low-pressure steam exiting the housing can be condensed back to liquid for reuse, enabling a closed-loop cycle with no water loss.

In some implementations, a plurality of turbine engines 1400 may be co-shafted to increase power output. For example, the plurality of turbine engines 1400 may be stacked on a common shaft 1410 to drive a plurality axial flux motors 1405 (FIGS. 14C and 14D), forming a high power (e.g., one-megawatt) turbine generator 1450. Through alternating-current to direct-current (AC-to-DC) conversion for temporary energy storage, followed by direct-current to alternating-current conversion, multiple generators 1450 may be synchronized to deliver a combined output of up to, for example, twelve megawatts of standard electrical power.

In FIG. 14D, unlike conventional turbine generator systems that typically employ a single large turbine engine coupled to a generator through one shaft, the disclosed configuration utilizes multiple (e.g., two) smaller, lightweight turbine engines 1400 positioned on opposite sides of one or more axial flux motors 1405, all connected by a common shaft 1410. This arrangement provides balanced torque distribution and smooth power delivery to the generator 1450, enhancing operational stability and efficiency. The design offers advantages similar to those observed in dual-engine versus single-engine propulsion systems or four-wheel-drive versus two-wheel-drive configurations.

A plurality of generators 1450 may be arranged for transport within a standard cargo container, enabling shipment to a deployment site without unpacking or conventional installation. Upon arrival, the generators can operate as a modular power generation unit by connecting to a high-pressure steam supply line. Low-pressure steam discharged from the generators may be routed to an external air-cooled condenser that converts the steam to liquid water for recirculation. The condenser may utilize a radiator-type coil and fan configuration, occupying substantially less space than conventional high-tower water-cooling systems. This compact design simplifies installation and supports closed-loop operation, minimizing water loss and promoting sustainable performance. For geothermal applications, the architecture allows incremental capacity expansion during operation by adding additional generators 1450.

The turbine engine 1400 may be scaled to meet different power demands. A small-scale version can utilize a household natural gas pipeline to generate high-pressure steam that drives an axial flux motor 1405 for residential electricity. Medium-scale configurations may power industrial facilities directly, eliminating reliance on transmission lines, transformers, and centralized grids, which typically cause energy losses and require costly maintenance. Exhaust gases containing carbon dioxide and water vapor from the boiler can be directed to a greenhouse, where photosynthesis accelerates plant growth and produces oxygen, creating an environmentally beneficial system.

The turbine engine 1400 may be configured to provide mechanical propulsion for a wide range of vehicles or platforms, including but not limited to marine vessels, aircraft, land-based vehicles, and other mobile or stationary systems requiring rotational power. FIG. 14E depicts a turbine engine configured as a propulsion assembly, in accordance with some aspects. The turbine engine 1400 may be coupled to an axial flux motor 1405 through a shaft 1410 for converting rotational energy into electrical power, while another shaft 1410 may be coupled to a propeller 1420 to provide mechanical thrust for propulsion. A condenser system 1425 may be configured to condense low-pressure steam discharged from the turbine engine 1400 into liquid water for recirculation within a closed-loop cycle. This propulsion assembly 1430 may include a high-pressure steam input, an electrical output in alternating current or direct current form for powering onboard systems, and a liquid-state steam output Oₛ for reuse.

In some aspects, the turbine engine may serve as a propulsion system for various platforms, including marine vessels and aircraft. Its lightweight and modular design allows installation on an aircraft or integration into a marine vessel as a propeller drive system. For large ships, a steam turbine propulsion engine can be mounted externally to the hull near the propeller, enabling direct mechanical drive of heavy propeller assemblies. Unlike propulsion systems that rely on large electric motors and complex electronics, the steam turbine propulsion engine includes primarily of mechanical components, reducing maintenance requirements and improving reliability.

The turbine engine may be implemented as part of an electric vehicle power system. In some aspects, the turbine engine is coupled to a generator, such as a permanent magnet motor, and an electrical control unit that includes a three-phase AC-to-DC rectifier. This configuration enables the system to function as a high-efficiency, quiet, lightweight, and compact power source comparable to a large lithium-ion battery. Energy recovery may be achieved through supercapacitors that store kinetic energy during braking or deceleration, reducing reliance on conventional battery recharging and eliminating the need for external charging stations. The turbine engine, combined with the permanent magnet motor generator, can be integrated into existing electric vehicles without requiring substantial retooling of existing components.

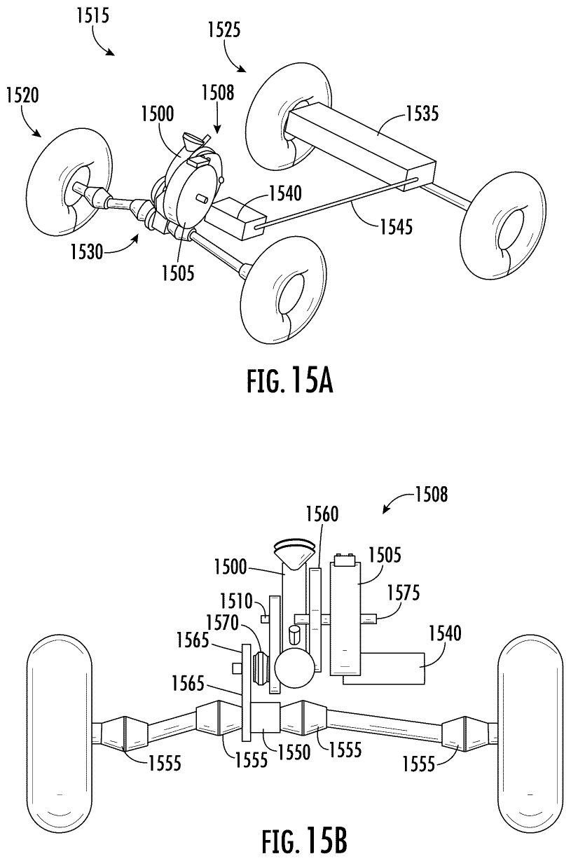

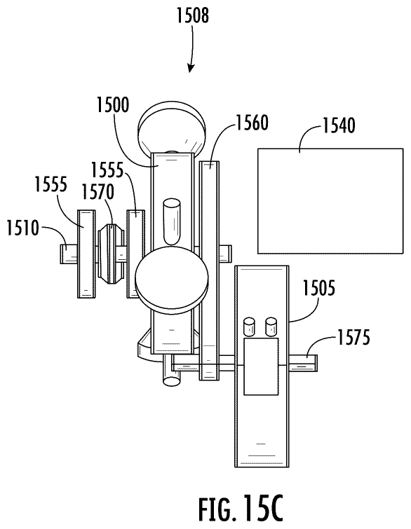

FIG. 15A is a perspective view of a turbine engine on a hybrid vehicle, FIG. 15B is a front view of a turbine engine on a front portion of a hybrid vehicle, and FIG. 15C is a close-up top view of a turbine engine on a front portion of a hybrid vehicle as shown in FIGS. 15A and 15B, all in accordance with some aspects. A turbine engine 1500 may be provided in a compact design suitable for integration into a hybrid engine system 1508 of a vehicle. For example, the turbine engine with an axial flux motor may be directly connected to an existing transmission (e.g., gearbox), thereby converting a vehicle into a hybrid engine vehicle. In an example implementation, the turbine engine is coupled to an axial flux motor to form a hybrid engine assembly for use in a hybrid vehicle. The hybrid vehicle may be configured in a front-wheel-drive arrangement.

A turbine engine 1500 may be operatively coupled to a motor such as an axial flux motor 1505 to create a hybrid engine assembly 1508 for a vehicle 1515. The vehicle 1515 may further include a front wheel assembly 1520, a rear wheel assembly 1525, and a front wheel drivetrain assembly 1530 configured to transmit torque from the hybrid engine assembly 1508. A battery pack 1535 is electrically connected to a converter/inverter electric box 1540 by high-current, high-voltage conductors such as wires 1545, with the converter/inverter electric box 1540 being configured to regulate power flow between the battery pack 1535 and the axial flux motor 1505.

The hybrid engine assembly 1508 is operatively connected to a differential gearbox 1550 and constant velocity (CV) joints 1555 to transmit torque to the front wheel assembly 1520 and the rear wheel assembly 1525. During vehicle startup, power may be supplied by the battery pack 1535, which delivers high-voltage current through wires 1545 to convertor/invertor electric box 1540. The converter/inverter electric box 1540 regulates power to the axial flux motor 1505, which produces high torque to accelerate the vehicle 1515. The axial flux motor 1505 drives the front wheels of the front wheel assembly 1520 in the forward direction. In some examples, the axial flux motor 1505 may produce up to 200 kW peak power and 790 Nm torque.

During vehicle cruising, power may instead be provided by the turbine engine 1500. As described herein with reference to FIG. 7A, the sparkplug ignites the fuel-air mixture within the combustion chamber, causing an explosion. Dispelled gases cause the turbine rotor of the turbine engine 1500 to rotate, transmitting torque through the shaft 1510 and the front wheel drivetrain assembly 1530 to rotate the front wheels of the front wheel assembly 1520 forward. The vehicle 1515 may employ the turbine engine 1500 to maintain cruising speed. In some implementations, the turbine engine 1500 operates at a thermal efficiency greater than 60%, and improved fuel economy (miles per gallon, MPG) may be achieved. By comparison, conventional gasoline piston engine-based hybrid vehicles typically operate at a thermal efficiency of about 35%, while diesel piston engine-based trucks generally achieve a practical thermal efficiency in the range of approximately 30% to 45%.

The drivetrain may include constant velocity (CV) joints 1555, a differential gearbox 1550, a coupling gear 1560 interconnecting the turbine engine 1500 and the axial flux motor 1505, one or more gears 1565, and a clutch 1570. Collectively, these components permit torque to be selectively transferred from the turbine engine 1500, the axial flux motor 1505, or from both in combination, depending on operating conditions. For example, a gear 1565 may be disposed between the shaft 1510 of the turbine engine 1500 and the shaft 1575 of the axial flux motor 1505 to provide a speed ratio that compensates for differences in rotational speeds (e.g., revolutions per minute, RPM) between the shafts. A clutch 1570 may be configured to selectively disengage the turbine engine 1500 and the axial flux motor 1505 from the wheel drivetrain, for instance during operation of the turbine engine 1500 in a generator mode. In some implementations, additional gears 1565 may be positioned between the turbine engine 1500, the axial flux motor 1505, and the wheel drivetrain shaft to further balance RPM disparities among the interconnected components.

In the front-wheel-drive vehicle example, a reverse driving mode may be provided to enable the vehicle 1515 to move backward. To achieve this, the converter/inverter electric box 1540 may control the axial flux motor 1505 to operate in a reverse rotational direction. When the driver applies the brakes or releases the accelerator, the kinetic energy of the wheels may drive the axial flux motor 1505 in a generator mode to recharge the battery pack 1535, thereby improving overall fuel efficiency, such as by approximately 10%. During high-power demand conditions, such as when the vehicle 1515 travels uphill, both the turbine engine 1500 and the axial flux motor 1505 may operate together to deliver increased torque to the drivetrain. During cruising, when the battery level of the axial flux motor 1505 is low, the turbine engine 1500 may simultaneously propel the vehicle 1515 and generate electrical power through the axial flux motor 1505 to recharge the battery pack 1535. An additional benefit of the hybrid configuration is that the turbine engine 1500, in combination with the axial flux motor 1505, enables the vehicle 1515 to function as a mobile, high-capacity, high-efficiency, and low-noise electric generator.

In some implementations, a plurality of turbine engines may be arranged along a common shaft to operate cooperatively as a single unit, thereby increasing overall power output. Likewise, a plurality of axial flux motors may be employed. In certain implementations, the number of turbine engines may correspond to the number of axial flux motors, while in other implementations fewer turbine engines than axial flux motors may be utilized. When interconnected in this manner, the hybrid engine assembly may be configured for use in heavy-duty vehicles, such as a semi-truck or other Class 8 truck applications.

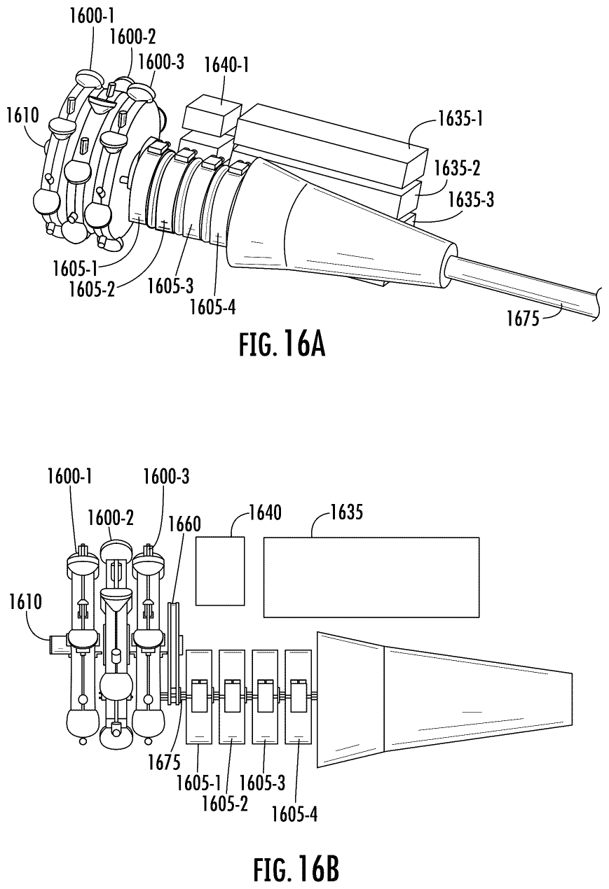

FIGS. 16A and 16B illustrate, respectively, a perspective view and a top view of a plurality of turbine engines arranged for a hybrid heavy-duty vehicle, both in accordance with some aspects. A plurality of turbine engines 1600 (e.g., 1600-1, 1600-2, 1600-3 . . . 1600-n) are arranged along a shaft 1610, and a plurality of axial flux motors 1605 (e.g., 1605-1, 1605-2, 1605-3 . . . 1605-n) are arranged along a shaft 1675. A coupling gear 1660 connects the turbine engine 1600 and the axial flux motor 1605. A battery pack 1635 (e.g., 1635-1, 1635-2, 1635-3 . . . 1635-n) is electrically connected to a converter/inverter electric box 1640 (e.g., 1640-1, 1640-2, 1640-3 . . . 1640-n)which is configured to regulate power flow between the battery pack 1635 and the axial flux motor 1605.

Reference has been made in detail to aspects of the disclosed invention, one or more examples of which have been illustrated in the accompanying figures. Each example has been provided by way of explanation of the present technology, not as a limitation of the present technology. In fact, while the specification has been described in detail with respect to specific example of the invention, it will be appreciated that those skilled in the art, upon attaining an understanding of the foregoing, may readily conceive of alterations to, variations of, and equivalents to these examples. For instance, features illustrated or described as part of one example may be used with another example to yield a still further example. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A turbine engine comprising:
a housing defining an interior cavity;
a shaft extending axially through the housing;
a turbine rotor coupled to the shaft, the turbine rotor comprising:
a hub configured to couple to the shaft;
a plurality of spokes extending radially outward from the hub;
a plurality of blades, each blade disposed at a distal end of a corresponding spoke of the plurality of spokes and shaped as a hollow spherical shell having an opening, the opening oriented to receive a working fluid and direct the working fluid tangentially to impart rotational motion to the turbine rotor;
an inlet coupled to the housing and configured to direct the working fluid into the interior cavity; and
an exhaust pipe coupled to the housing and configured to discharge residual gases from the housing.

2. The turbine engine of claim 1, wherein the opening of each blade comprises a sector-shaped cutout in a portion of the spherical shell, the opening extending circumferentially around the blade and spanning an angular range, the opening defining a concave recess that conforms to a curvature of the spherical shell.

3. The turbine engine of claim 2, wherein the angular range is approximately 120°.

4. The turbine engine of claim 1, wherein the opening of each blade comprises a tapered cutout on the spherical shell, the cutout having a first end width that differs from a second end width such that the cutout transitions in size along its length.

5. The turbine engine of claim 4, wherein the first end width corresponds to a diameter of the inlet, and the second end width corresponds to a diameter of the exhaust pipe.

6. The turbine engine of claim 1, wherein each blade further comprises a baffle positioned within the hollow spherical shell and adjacent to the opening.

7. The turbine engine of claim 6, wherein the baffle includes a hole configured to vent or equalize pressure within the blade.

8. The turbine engine of claim 1, wherein the interior cavity of the housing comprises an annular passage having a toroidal shape, the annular passage dimensioned to accommodate the turbine rotor and the plurality of blades within the annular passage.

9. The turbine engine of claim 1, wherein the shaft is oriented along a vertical axis or a horizontal axis.

10. The turbine engine of claim 1, wherein the working fluid comprises steam supplied from an external source, and the turbine engine operates without a combustion chamber.

11. The turbine engine of claim 1, wherein the working fluid comprises combustion gases generated within a combustion chamber coupled to the housing, the combustion chamber configured to receive a fuel and oxidizer mixture and expel the combustion gases through an outlet aligned with the inlet of the housing.

12. The turbine engine of claim 1, wherein the turbine engine includes an equal number of inlets and exhaust pipes arranged in corresponding positions around the housing.

13. The turbine engine of claim 1, wherein the turbine rotor comprises a first turbine rotor half and a second turbine rotor half, each turbine rotor half comprising:
a hub segment configured to couple to a shaft about an axis of rotation;
a plurality of spokes extending radially outward from the hub segment; and
a plurality of blade half-shells at a distal end of a corresponding spoke, each blade half-shell being positioned to mate with a corresponding blade half-shell of the other turbine rotor half.

14. The turbine engine of claim 1, wherein the housing comprises a first enclosure and a second enclosure, and is integrally formed with the inlet and the exhaust pipe.

15. The turbine engine of claim 1, further comprising a thrust ball bearing, the thrust ball bearing positioned between the housing and the turbine rotor.

16. The turbine engine of claim 1, wherein the shaft is coupled to a motor, generator, transmission, wheel assembly, propeller, power conversion or propulsion system.

17. A turbine rotor comprising:
a hub configured to couple to a shaft;
a plurality of spokes extending radially outward from the hub; and
a plurality of blades, each blade disposed at a distal end of a corresponding spoke and shaped as a hollow spherical shell having an opening, the opening oriented to receive a working fluid and direct the working fluid tangentially to impart rotational motion to the turbine rotor.

18. The turbine rotor of claim 17, wherein the opening of each blade comprises a sector-shaped cutout in a portion of the spherical shell, the opening extending circumferentially around the blade and spanning an angular range, the opening defining a concave recess that conforms to a curvature of the spherical shell.

19. The turbine rotor of claim 18, wherein the angular range is approximately 120°.

20. The turbine rotor of claim 17, wherein the opening of each blade comprises a tapered cutout on the spherical shell, the cutout having a first end width that differs from a second end width such that the cutout transitions in size along its length.

21. The turbine rotor of claim 17, wherein each blade further comprises a baffle positioned within the spherical shell adjacent to the opening.

22. The turbine rotor of claim 21, wherein the baffle includes an air hole configured to vent or equalize pressure within the blade.

23. The turbine rotor of claim 17, wherein the shaft is oriented along a vertical axis or a horizontal axis.

24. The turbine rotor of claim 17, wherein the turbine rotor comprises a first turbine rotor half and a second turbine rotor half, each turbine rotor half comprising:
a hub segment configured to couple to a shaft about an axis of rotation;
a plurality of spokes extending radially outward from the hub segment; and
a plurality of blade half-shells at a distal end of a corresponding spoke, each blade half-shell being positioned to mate with a corresponding blade half-shell of the other turbine rotor half.

25. A method for manufacturing a turbine engine, the method comprising:
forming a first turbine rotor half and a second turbine rotor half, each turbine rotor half comprising:
a hub segment configured to couple to a shaft about an axis of rotation;
a plurality of spokes extending radially outward from the hub segment; and
a plurality of blade half-shells at a distal end of a corresponding spoke, each blade half-shell being positioned to mate with a corresponding blade half-shell of the other turbine rotor half;
coupling the first turbine rotor half to the second turbine rotor half forming a turbine rotor;
forming a housing comprising a first enclosure and a second enclosure, and integrally forming with the housing an inlet and an exhaust pipe; and
coupling the first enclosure to the second enclosure with the turbine rotor positioned between the first enclosure and the second enclosure;
wherein when the first turbine rotor half and the second turbine rotor half are coupled, each mated blade is shaped as a hollow spherical shell having an opening, the opening oriented to receive a working fluid and direct the working fluid tangentially to impart rotational motion to the turbine rotor.

26. The method of claim 25, wherein a thrust ball bearing is positioned between the housing and the turbine rotor.
